(19) United States
(12) Patent Application Publication
(10) Pub. No.: US 2018/0113502 A1
(43) Pub. Date: Apr. 26, 2018

(54) ON-CHIP CLOSED LOOP DYNAMIC VOLTAGE AND FREQUENCY SCALING

(71) Applicant: NVIDIA Corporation, Santa Clara, CA (US)

(72) Inventors: Tezaswi RAJA, San Jose, CA (US); Rohit SINGHAL, San Jose, CA (US)

(21) Appl. No.: 15/333,047

(22) Filed: Oct. 24, 2016

(51) Int. Cl. G06F 1/32; G06F 15/78

(52) U.S. Cl. CPC G06F 1/3296; G06F 15/7807; G06F 1/324; G06F 1/3215

(57) ABSTRACT

An apparatus for dynamic voltage and frequency scaling. The apparatus includes a plurality of voltage rails supplying a plurality of voltages for a system on a chip (SoC). The apparatus includes a plurality of engines integrated within the SoC. The plurality of engines is coupled to the plurality of voltage rails. The apparatus includes an on-chip dynamic voltage and frequency scaling (DVFS) module coupled to the plurality of engine. The DVFS module is configured to selectively couple each of the plurality of engines to one of the plurality of voltage rails depending on a corresponding performance request of a plurality of performance requests from the plurality of engines.

### CROSS-REFERENCE TO RELATED APPLICATIONS

This application is related to U.S. patent application Ser. No. 13/947,999, filed on Jul. 22, 2013, and entitled “Closed Loop Dynamic Voltage and Frequency Scaling,” the disclosure of which is hereby incorporated by reference in its entirety. This application is also related to U.S. patent application Ser. No. 14/876,332, filed on Oct. 6, 2015, and entitled “Voltage Optimization Circuit and managing Voltage Margins of an Integrated Circuit,” the disclosure of which is hereby incorporated by reference in its entirety. This application is also related to U.S. patent application Ser. No. 14/323,787, entitled “CLOCK GENERATION CIRCUIT THAT TRACKS CRITICAL PATH ACROSS PROCESS, VOLTAGE AND TEMPERATURE VARIATION,” the disclosure of which is hereby incorporated by reference in its entirety.

### BACKGROUND

A system on a chip (SoC) includes many engines that require voltage. As an illustration, engines may include processing units, core processing units, encoders, decoders, display unit, etc. Each of the engines has a corresponding voltage/frequency curve that defines an optimum relationship between the two variables. That is, for an engine that requires a certain clocked frequency for operation, the corresponding voltage (Vdd) that can be supplied is determined from the corresponding voltage/frequency curve. Similarly, a frequency may be determined when an engine requires a certain voltage using the same voltage/frequency curve. As such, the voltage/frequency curve provides a plurality of voltage/frequency points that define optimum operation for that engine.

For example, a browser application driven by an engine may require for optimum performance a very high frequency when downloading a web page. The corresponding voltage that can be supplied to maintain the frequency is determined from a corresponding voltage/frequency curve. After the web page has downloaded, the engine may no longer require such a high frequency as its demands are lower (e.g., scrolling through the downloaded web page), and as such the supplied voltage may be adjusted according to the corresponding voltage/frequency curve to match the lowered frequency of operation.

The plurality of engines is typically coupled to a common voltage rail that supplies a voltage, such as Vdd. The voltage rail is controlled by a power management integrated circuit (PMIC) that is located off-chip (i.e., remote from the SoC). The voltage/frequency curve may be different for each of the plurality of engines. As a result, at any given moment in time, the plurality of engines may require any number of frequencies, each of which may require a different voltage according to their respective voltage/frequency curves. To accommodate all the engines, the PMIC will raise the delivered Vdd to the highest required voltage for all the requesting engines coupled to the voltage rail. In that manner, none of the engines will fail by running at too low of a frequency.

However, by running all the engines at the highest required voltage, the SoC will be inefficient because all but one of the engines will not be running at their optimum frequency/voltage points. Power is wasted in engines that are running at non-optimal voltage according to their voltage/frequency curve as the actual voltage is higher due to some other engine. The wasted power is related to the difference in the two voltages. This power wastage is magnified with each additional engine running under less than optimal conditions.

Additionally, because the PMIC is located off-chip, the amount of time required to determine the appropriate highest required voltage at any point in time may be long or on the order of tens of micro-seconds. This is because requested frequencies must be gathered, then the highest required voltage is determined from the plurality of voltage/frequency curves, then a request is delivered to the PMIC for requesting the voltage, and finally the PMIC delivers the requested voltage. At least some of the processing and communications occurs off-chip, thereby introducing additional delay. The longer the delay, the more power is wasted, especially if the SoC is powering down to a lower voltage.

It is desirable to have a voltage delivery system that is capable of supplying different voltages to a plurality of engines of a SoC.

### SUMMARY

Power management for an integrated circuit (IC) device is described herein. In particular, an example embodiment of the present invention is described in relation to closed loop dynamic voltage and frequency scaling for power management in a SoC.

In embodiments of the present invention, a method for power management is disclosed. The method includes receiving a first performance request from a first engine of a SoC. The method includes determining a first voltage and frequency point based on the first performance request. The first voltage and frequency point comprises a first requested voltage. The method includes determining a first voltage rail of a plurality of voltage rails having a first voltage that is closest to the first requested voltage, wherein the first voltage is equal to or greater than the first requested voltage. The method includes coupling the first engine to the first voltage rail independently of other engines in the SoC.

In other embodiments of the present invention, another method for power management is disclosed. The method includes selectively coupling each of a plurality of engines of a SoC to one of a plurality of voltage rails. The coupling of an engine to a voltage rail is dependent on a corresponding performance request of the engine. The performance request is one of a plurality of performance requests received from the plurality of engines. The method includes, for a corresponding engine, adjusting a voltage received from a corresponding voltage rail to match a requested voltage that is based on a corresponding performance request. The voltage adjusting may be accomplished using a corresponding low dropout (LDO) regulator that is coupled between the corresponding engine and the corresponding voltage rail. Further, the requested voltage is determined from a corresponding voltage and frequency point based on the corresponding performance request. The voltage and frequency point comprises the corresponding requested voltage. Further, the voltage and frequency point is determined from a corresponding frequency vs. supply voltage curve associated with the corresponding engine.

In still another embodiment, an apparatus configured for power management is disclosed. The apparatus includes a plurality of voltage rails supplying a plurality of voltages to a SoC. The voltage rails are controlled by a PMIC that is located off-chip from a SoC. The apparatus includes a plurality of engines integrated within the SoC. The plurality of engines is coupled to the plurality of voltage rails. The apparatus includes a dynamic voltage and frequency scaling (DVFS) module coupled to the plurality of engines. The DVFS module is configured to selectively couple each of the plurality of engines to one of the plurality of voltage rails depending on a corresponding performance request of a plurality of performance requests from the plurality of engines.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 depicts a block diagram of an exemplary computer system suitable for implementing embodiments according to the present disclosure.

FIG. 2A is a block diagram illustrating the implementation of closed loop dynamic voltage and frequency scaling for purposes of power management to include a coarse tuning of voltage, in accordance with one embodiment of the present disclosure.

FIG. 2B is a block diagram illustrating another implementation of closed loop dynamic voltage and frequency scaling for purposes of power management to include a fine tuning of voltage, in accordance with one embodiment of the present disclosure.

FIG. 3 is a flow diagram illustrating a method for performing closed loop dynamic voltage and frequency scaling for power management, in accordance with one embodiment of the present disclosure.

FIG. 4 is a flow diagram illustrating another method for performing closed loop dynamic voltage and frequency scaling for power management, in accordance with one embodiment of the present disclosure.

### DETAILED DESCRIPTION OF THE INVENTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Accordingly, embodiments of the present invention provide for a fast and efficient dynamic voltage and frequency scaling mechanism. Embodiments of the present invention provide for a control loop implemented in hardware or software, or a combination of the two, wherein the control loop is completely contained on-chip to increase speed of operation. In particular, the control loop includes a dynamic clock source and a dynamic voltage source that are tuned in a matter of several nano-seconds, which is significantly faster than traditional control loop mechanisms which have loop times on the order of micro-seconds. As a result, the control loop of embodiments of the present invention is fast and efficient, and allows for a very aggressive and efficient DVFS policy.

Throughout this application, the term “SoC” may be analogous to the term “chip,” both defining an integrated circuit implemented on a single chip substrate. It may contain components of a computing system or other electronic system. In addition, the term “logic block” defines a specialized circuit design that performs one or more specific functions. The logic block may be integrated, in part, with other logic blocks to form a SoC. In addition, the term “logic block” may be analogous to the term “chiplet” or “design module.”

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computer system. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “launching,” “executing,” “accessing,” “setting,” “establishing,” or the like, refer to actions and processes (e.g., in flowcharts 4A-D of the present Application) of a computer system or similar electronic computing device or processor (e.g., computer system 100 and client device 200). The computer system or similar electronic computing device manipulates and transforms data represented as physical (electronic) quantities within the computer system memories, registers or other such information storage, transmission or display devices.

Throughout the specification, flowcharts of examples of computer-implemented methods for the closed loop dynamic voltage and frequency scaling used for power management are described, according to embodiments of the present invention. Although specific steps are disclosed in the flowcharts, such steps are exemplary. That is, embodiments of the present invention are well-suited to performing various other steps or variations of the steps recited in the flowcharts.

Other embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer storage media and communication media. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

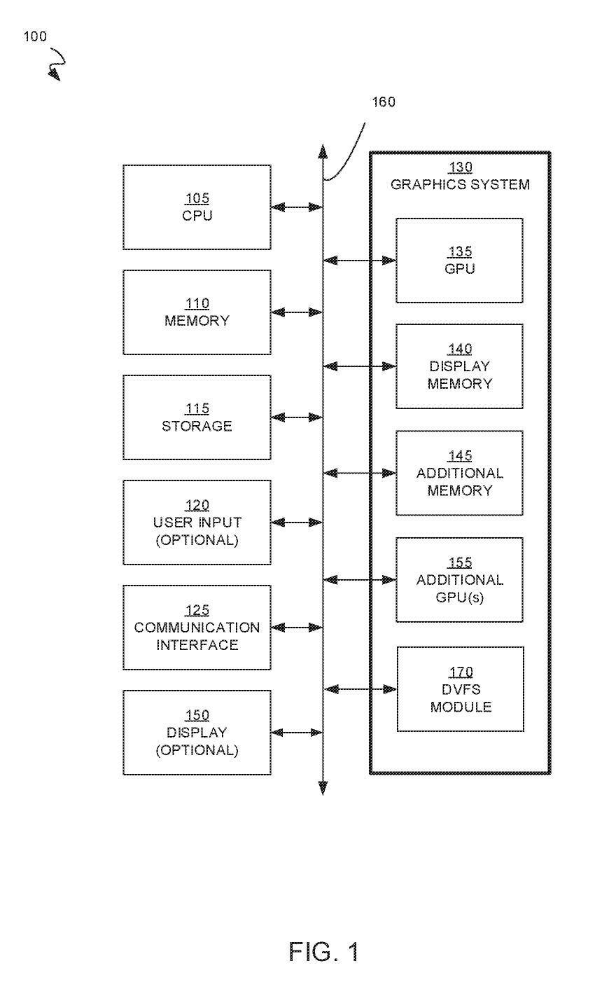

FIG. 1 is a block diagram of an example of a computing system 100 capable of implementing embodiments of the present disclosure. Computing system 100 broadly represents any single or multi-processor computing device or system capable of executing computer-readable instructions. Examples of computing system 100 include, without limitation, workstations, laptops, client-side terminals, servers, distributed computing systems, handheld devices, gaming systems, gaming controllers, or any other computing system or device. In its most basic configuration, computing system 100 may include at least one processor 105 and a system memory 110.

It is appreciated that computer system 100 described herein illustrates an exemplary configuration of an operational platform upon which embodiments may be implemented to advantage. Nevertheless, other computer system with differing configurations can also be used in place of computer system 100 within the scope of the present invention. That is, computer system 100 can include elements other than those described in conjunction with FIG. 1. Moreover, embodiments may be practiced on any system which can be configured to enable it, not just computer systems like computer system 100. It is understood that embodiments can be practiced on many different types of computer systems 100. System 100 can be implemented as, for example, a desktop computer system or server computer system having a power general-purpose CPUs coupled to a dedicated graphics rendering GPU. In such an embodiment, components can be included that add peripheral buses, specialized audio/video components, I/O devices, and the like. Similarly, system 100 can be implemented as a handheld device (e.g., cell phone, etc.) or a set-top video game console device, such as, for example Xbox®, available from Microsoft corporation of Redmond, Wash., or the PlayStation3®, available from Sony Computer Entertainment Corporation of Tokyo, Japan, or the any of the SHIELD Portable devices (e.g., handheld gaming console, tablet computer, television set-top box, etc.) available from Nvidia Corp. System 100 can also be implemented as a “system on a chip”, where the electronics (e.g., the components 105, 110, 115, 120, 125, 130, 150, and the like) of a computing device are wholly contained within a single integrated circuit die. Examples include a hand-held instrument with a display, a car navigation system, a portable entertainment system, and the like.

In the example of FIG. 1, the computer system 100 includes a central processing unit (CPU) 105 for running software applications and optionally an operating system. Memory 110 stores applications and data for use by the CPU 105. Storage 115 provides non-volatile storage for applications and data and may include fixed disk drives, removable disk drives, flash memory devices, and CD-ROM, DVD-ROM or other optical storage devices. The optional user input 120 includes devices that communicate user inputs from one or more users to the computer system 100 and may include keyboards, mice, joysticks, touch screens, and/or microphones.

The communication or network interface 125 allows the computer system 100 to communicate with other computer systems via an electronic communications network, including wired and/or wireless communication and including the internet. The optional display device 150 may be any device capable of displaying visual information in response to a signal from the computer system 100. The components of the computer system 100, including the CPU 105, memory 110, data storage 115, user input devices 120, communication interface 125, and the display device 150, may be coupled via one or more data buses 160.

In the embodiment of FIG. 1, a graphics system 130 may be coupled with the data bus 160 and the components of the computer system 100. The graphics system 130 may include a physical graphics processing unit (GPU) 135 and graphics memory. The GPU 135 generates pixel data for output images from rendering commands. The physical GPU 135 can be configured as multiple virtual GPUs that may be used in parallel (concurrently) by a number of applications executing in parallel.

Graphics memory may include a display memory 140 (e.g., a frame buffer) used for storing pixel data for each pixel of an output image. In another embodiment, the display memory 140 and/or additional memory 145 may be part of the memory 110 and may be shared with the CPU 105. Alternatively, the display memory 140 and/or additional memory 145 can be one or more separate memories provided for the exclusive use of the graphics system 130.

In another embodiment, graphics processing system 130 includes one or more additional physical GPUs 155, similar to the GPU 135. Each additional GPU 155 may be adapted to operate in parallel with the GPU 135. Each additional GPU 155 generates pixel data for output images from rendering commands. Each additional physical GPU 155 can be configured as multiple virtual GPUs that may be used in parallel (concurrently) by a number of applications executing in parallel. Each additional GPU 155 can operate in conjunction with the GPU 135 to simultaneously generate pixel data for different portions of an output image, or to simultaneously generate pixel data for different output images.

Each additional GPU 155 can be located on the same circuit board as the GPU 135, sharing a connection with the GPU 135 to the data bus 160, or each additional GPU 155 can be located on another circuit board separately coupled with the data bus 160. Each additional GPU 155 can also be integrated into the same module or chip package as the GPU 135. Each additional GPU 155 can have additional memory, similar to the display memory 140 and additional memory 145, or can share the memories 140 and 145 with the GPU 135.

In addition, a DVFS module 170 may be included within the graphics system 130, in one embodiment. In another embodiment, the DVFS module 170 is located on a SoC that is separate from the graphics system 130. The DVFS module 170 is configured to perform fast and efficient dynamic voltage and frequency scaling. The solution implements a control loop completely contained on-chip (e.g., SoC), and therefore is significantly faster than a solution that involves an off-chip PMIC.

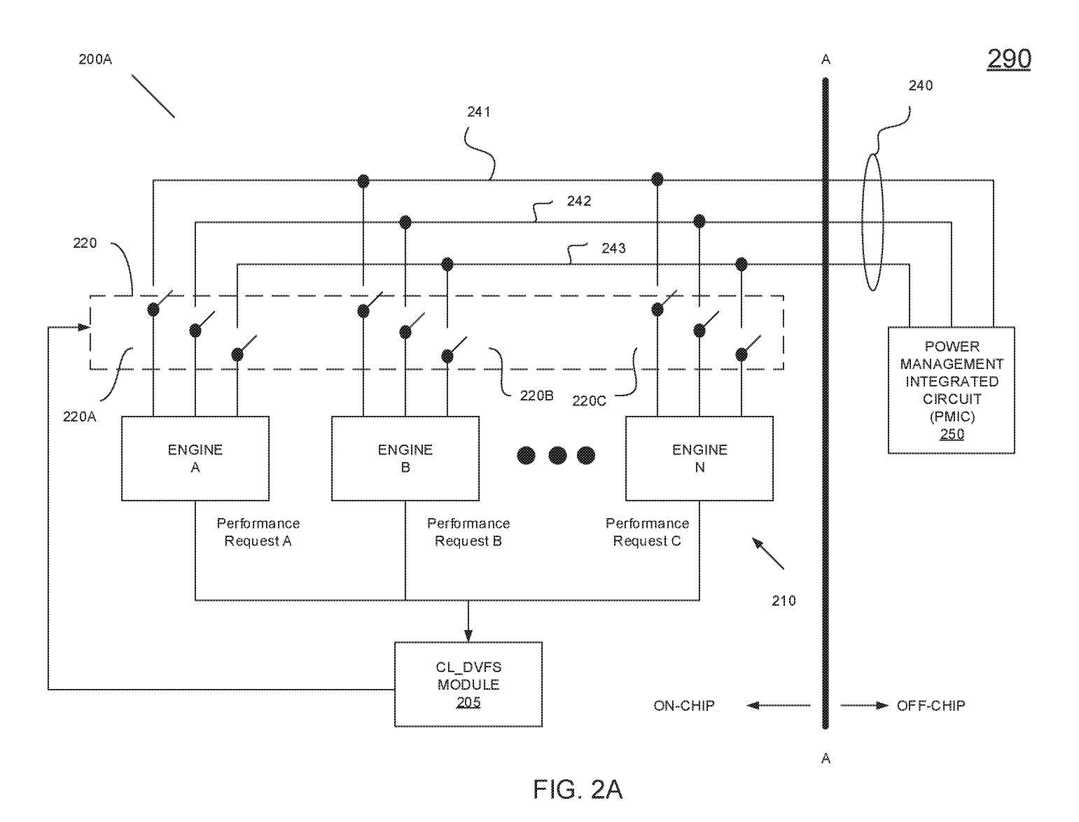

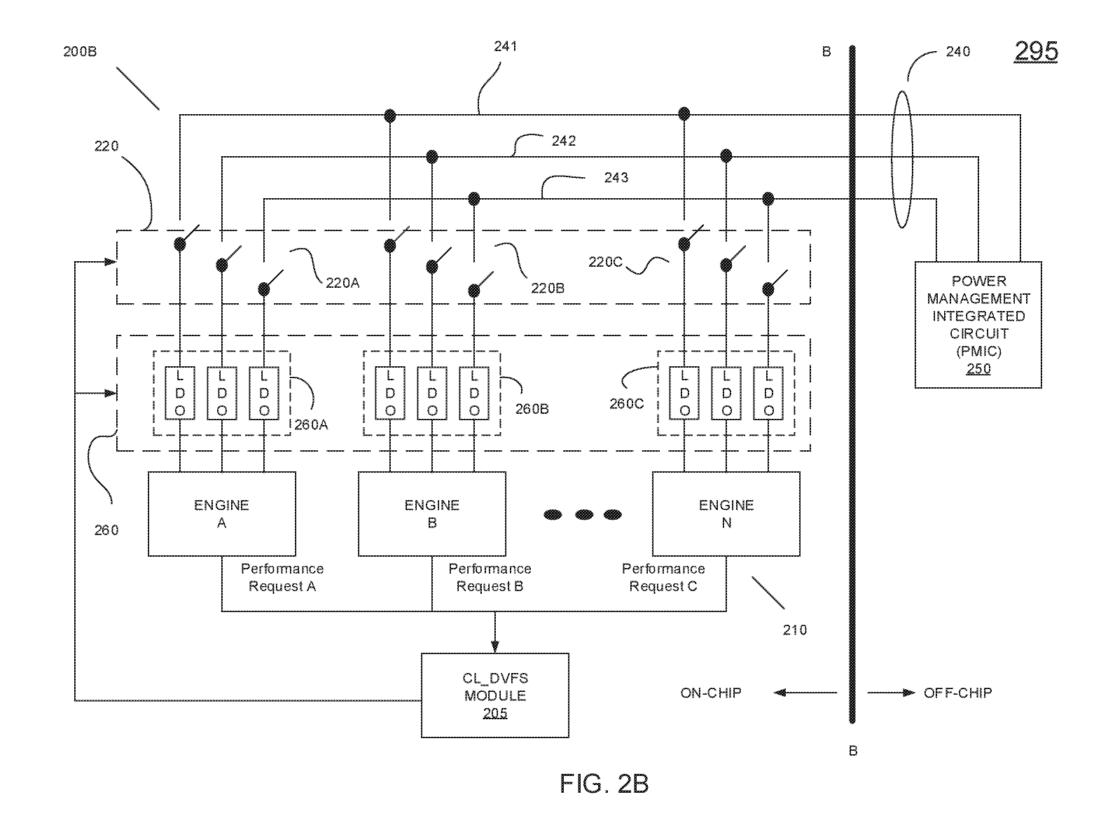

FIG. 2A is a block diagram of a system 290 illustrating the implementation of closed loop dynamic voltage and frequency scaling for purposes of power management to include a coarse tuning of voltage, in accordance with one embodiment of the present disclosure. In particular, power management for a SoC 200A of FIG. 2A is described in relation to closed loop dynamic voltage and frequency scaling for power management. In particular, embodiments of the present invention provide for independently programming desired (e.g., requested) target operational frequencies of one or more engines of the SoC 200A. Operation of the SoC 200A at one of its target clock frequencies also determines a level for adjusting the core supply voltage (Vdd) based on a corresponding frequency vs. supply voltage curve for a corresponding engine. As such, the corresponding engine is run at its optimal voltage for a given frequency, which conserves power and minimizes current draw.

As shown in FIG. 2A, a SoC 200A is shown to the left of line A-A in the system 290, and includes a plurality of engines 210 (e.g., engines A-N). For example, SoC 200A comprises an integrated circuit that includes one or more components of an electronic system, and is typically configured onto a single chip substrate. For purposes of illustration only, in SoC 200A, an engine may be configured as processing units, core processing units, encoders, decoders, display unit, etc. Each of the engines has a corresponding frequency vs. supply voltage curve that defines an optimum relationship between the two variables. As such, each of the engines may require a different and/or unique voltage level with respect to corresponding requested operating frequencies to achieve optimum performance at a given moment in time.

To improve efficiency, an ideal power distribution network may be configured such that each engine has its own separate variable voltage rail that is directly supplied from the PMIC 250, in one embodiment. The PMIC 250 may be independent of the SoC 200A, and is configured to regulate and/or control the voltage levels supplied over the plurality of voltage rails 240. In one embodiment, over a period of time, the voltages supplied over the voltage rails 240 are constant, such that tuning of the voltages received by the plurality of engines 210 is performed on-chip at the SoC 200A. As shown in FIG. 2A, the PMIC 250 may be disposed (e.g., mounted on and electrically and communicatively coupled to) on a PCB that includes the SoC 200A, on which the SoC 200A is also disposed.

However, supplying N rails for N engines may be practically difficult, and/or costly to implement. Further, voltage management by the PMIC may introduce delays when changing voltage levels on a voltage rail because off-chip communications must be effected. Other embodiments of the present invention provide for dynamic voltage and frequency scaling for power management that is implemented on-chip. In particular, in other embodiments of the invention, multiple voltage rails 240 may be provided for selection by each of the engines, wherein the number of voltage rails may be less than the number of engines. As shown in FIG. 2A, the plurality of voltage rails 240 includes voltage rails 241, 242, and 243, for purposes of illustration only. Other embodiments may include more than three voltage rails, or less than three voltage rails. The plurality of engines 210 is coupled to the plurality of voltage rails 240. That is, instead of having a one-to-one relationship between engines and voltage rails, a smaller number of voltage rails is configurable to support a larger number of engines.

In addition, SoC 200A includes a dynamic voltage and frequency scaling (DVFS) module 205. The CL-DVFS module 205 is coupled to the plurality of engines 210, and is configured to control or regulate the supply voltage (e.g., Vdd) that is supplied to each of the rails (e.g., 241, 242, and 243). Because the DVFS module 205 is located on-chip (i.e., on the SoC 200A), control of the supply voltage levels is implemented without the use of the off-chip PMIC 250. Specifically, the DVFS module 205 is configured to selectively couple each of the plurality of engines 210 to one of the plurality of voltage rails 240 based on a corresponding performance request. For a particular engine, a corresponding performance request is received and/or determined. In one embodiment, the performance request is determined by the corresponding engine. For example, at a particular moment, a clock frequency may be determined and requested by the engine in consideration of the task being performed for optimum performance.

Other engines may be requesting different optimal performance characteristics (e.g., clock frequencies). As shown in FIG. 2A, engine A has determined its performance requirements, and is sending a Performance Request A to the CL-DVFS module 205. For example, the performance request may be a specific clock frequency. Also, engine B has determined its performance requirements, and is sending a Performance Request B to the CL-DVFS module 205. In addition, engine C has determined its performance requirements, and is sending a Performance Request C to the CL-DVFS module 205.

In one embodiment, CL_DVFS module 205 performs closed loop dynamic voltage and frequency scaling. That is, CL_DVFS 205 is configured to control or regulate the supply voltage (Vdd) that is supplied to any of the plurality of engines 210 based on the corresponding received performance request. As shown in FIG. 2A, for purposes of coarse tuning, the CL_DVFS 205 is configured to select the appropriate voltage rail for a corresponding engine and its performance request. In particular, CL_DVFS 205 selects the voltage rail that is closest to the required voltage based on the performance request, wherein the voltage supplied by the selected voltage rail is the closest to the required voltage, when compared to all voltages supplied by the plurality of voltage rails, and wherein the voltage supplied is equal to or greater than the required voltage. In particular, CL_DVFS 205 is able to control a plurality of switches 220, for example, that are configured to couple the appropriate voltage rail to the corresponding engine. As previously described, the required voltage is determined from a frequency vs. supply voltage curve corresponding to the requesting engine based on the performance request (e.g., a frequency request).

For example, CL_DVFS 205 is configured to select the appropriate voltage rail for engine A and its corresponding performance request. The performance request is associated with a requested frequency and/or requested voltage based on the corresponding frequency vs. supply voltage curve. For coarse tuning, the CL_DVFS 205 is configured to select between the voltage rails 241, 242, and 243 using the appropriate switch from the set of switches 220A. Similarly, for engine B and its corresponding performance request, the CL_DVFS 205 is configured to select between the voltage rails 241, 242, and 243 using the appropriate switch from the set of switches 220B. Further, for engine C and its corresponding performance request, the CL_DVFS 205 is configured to select between the voltage rails 241, 242, and 243 using the appropriate switch from the set of switches 220C.

In a closed-loop mode operation, the control loop includes a dynamic clock source and a dynamic voltage source that can be tuned quickly (e.g., within several nano-seconds). In one embodiment, the clock source and the voltage source are tuned independently. In other embodiments, the clock source and the voltage source are tuned together, such that the frequency and the voltage are used as inputs to the closed loop system.

For example, the output to a digitally parameterizable voltage controlled oscillator (DVCO) (not shown) provides a dynamic clock source. The DVCO is described in the references to U.S. patent application Ser. No. 13/947,999, entitled “Closed Loop Dynamic Voltage and Frequency Scaling,” and/or U.S. patent application Ser. No. 14/876,332, entitled “Voltage Optimization Circuit and managing Voltage Margins of an Integrated Circuit,” and U.S. patent application Ser. No. 14/323,787, entitled “CLOCK GENERATION CIRCUIT THAT TRACKS CRITICAL PATH ACROSS PROCESS, VOLTAGE AND TEMPERATURE VARIATION.” In one embodiment, the closed loop operating mode allows the CL_DVFS 205 to maintain the target output frequency of the DVCO at a desired value for optimum performance of the corresponding engine of the SoC 200A. As an example, the CL-DVFS module 205 maintains the target frequency by constantly updating adjustments to the voltage that is supplied to the corresponding engine. In one embodiment, the voltage is adjusted using a low dropout (LDO) regulator until the frequency error between the desired frequency and the frequency output achieved with the DVCO reaches a value of zero, as will be described below in FIG. 2B.

FIG. 2B is a block diagram of a system 295 illustrating another implementation of closed loop dynamic voltage and frequency scaling for purposes of power management to include both a coarse tuning and a fine tuning of voltages supplied to the plurality of engines 210 of SoC 200B, in accordance with one embodiment of the present disclosure. SoC 200B is shown to the left of line B-B. The SoC 200B of FIG. 2B is similarly configured as the SoC 200A of FIG. 2A, but includes additional components to effect fine tuning of the voltages supplied to the plurality of engines 210. For example, similar components between SoC 200A and SoC 200B includes, in part, a plurality of switches 220, a plurality of engines 210, and a CL_DVFS module 205. In both systems 290 of FIG. 2A and 295 of FIG. 2B, a PMIC 250 is configured to provide core supply voltages over the plurality of voltage rails 240.

In particular, power management for a SoC 200B of FIG. 2B is also described in relation to closed loop dynamic voltage and frequency scaling for power management. In particular, embodiments of the present invention provide for independently programming desired (e.g., requested) target operational frequencies of one or more engines of the SoC 200B. Operation of the SoC 200B at one of its target clock frequencies also determines a level for adjusting the core supply voltage (Vdd) based on a corresponding frequency vs. supply voltage curve for a corresponding engine. As such, the corresponding engine is run at its optimal voltage for a given frequency, which conserves power and minimizes current draw.

In addition, the CL_DVFS module 205 is coupled to the plurality of engines 210, and is configured to control or regulate the supply voltage (e.g., Vdd) that is supplied to each of the engines (e.g., 241, 242, and 243). In coarse tuning, the CL_DVFS module 205 is configured to selectively couple each of the plurality of engines 210 to one of the plurality of voltage rails 240 based on a corresponding performance request, as previously described. Fine tuning of the coarsely supplied voltages may be implemented through the use of a plurality of LDOs 260, such that for a particular engine the CL_DVFS module 205 provides a control signal to a corresponding LDO to adjust the coarsely selected voltage supplied over a corresponding voltage rail to the requested voltage corresponding to the performance request. The output, control signal of CL_DVFS 205 corresponds to the determined level for adjusting the core supply voltage that is supplied over a corresponding voltage rail, so as to operate the corresponding engine at its optimal target frequency and voltage.

An LDO is configured to adjust and/or regulate an output voltage that is supplied from a higher supply voltage. In particular, for a corresponding engine, a higher voltage received from a corresponding voltage rail is adjusted to match a lower, requested voltage based on a corresponding performance request using a corresponding LDO regulator coupled between the corresponding engine and the corresponding voltage rail. In general, an LDO effectively functions with feedback (e.g., the output voltage), which determines the optimal voltage automatically for a requested target frequency. As previously described, the requested voltage is determined from a corresponding voltage and frequency point based on the performance request for a corresponding engine. The frequency point comprises the corresponding requested voltage and/or a requested frequency. Further, the voltage and frequency point is determined from a corresponding frequency vs. supply voltage curve associated with the corresponding engine.

As shown in FIG. 2B, each of plurality of engines 210 is coupled to one or more LDOs. That is, the plurality of LDO regulators 260 is coupled between the plurality of engines 210 and the plurality of voltage rails 240, such that each of the engines is selectively coupled to a corresponding voltage rail via a corresponding LDO. For instance, one or more LDOs 260A is coupled between engine A and the plurality of voltage rails 240. Also, one or more LDOs 260B is coupled between engine B and the plurality of voltage rails 240. Further, one or more LDOs 260C is coupled between engine C and the plurality of voltage rails 240. In one embodiment, the outputs of the LDOs for a particular engine can be shorted. As such, the power source of an engine can be seamlessly and glitchlessly switched from one voltage rail to another (e.g., through a register setting).

In one embodiment, FIG. 2B shows one LDO coupled to a corresponding voltage rail in a one-to-one relationship for each of the engines. For example, engine A is coupled to three LDOs, each of which is coupled to one of three voltage rails 241, 242, and 243. However, other configurations of LDOs are supported in other embodiments of the present invention. For example, a single LDO may be coupled to a corresponding engine, wherein the LDO is selectively coupled to each of the plurality of voltage rails during coarse tuning, such as through a multiplexor. In that manner, the LDO is able to fine tune the coarsely selected voltage supplied from a selected voltage rail based on the control signals received from the CL_DVFS module 205.

In one embodiment, individual voltage islands can be controlled using hardware included within each engine. That is, the functions provided by the CL_DVFS module 205 are provided using hardware, to include selection of the corresponding voltage rail and corresponding LDO. Implementation within hardware increases the speed of operation over an inter-integrated bus (I²C)/PMIC communication loop.

Further, a software implementation of the functions provided by the CL_DVFS module 205 programs the frequency of the DVCO for adjusting the fine tuning of the voltage output from the LDO, in accordance with one embodiment of the present disclosure. In one embodiment, a phase locked loop (PLL) is used in placed of the DVCO for engines that cannot tolerate the jitter of the DVCO.

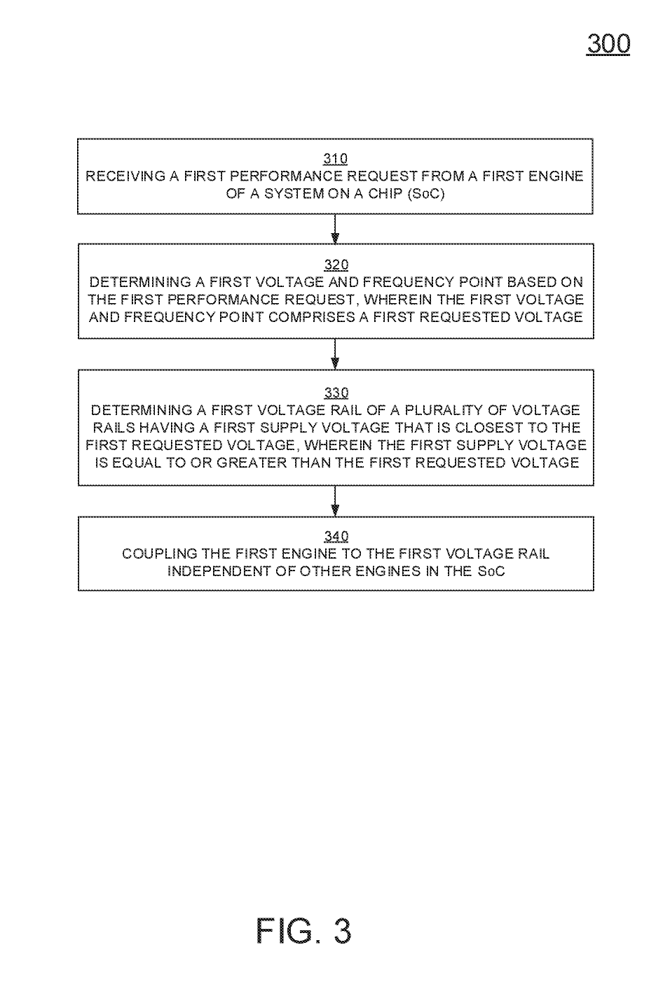

FIG. 3 is a flow diagram 300 illustrating a method for performing closed loop dynamic voltage and frequency scaling for power management of a SoC, in accordance with one embodiment of the present disclosure. In still another embodiment, flow diagram 300 illustrates a computer implemented method for performing closed loop dynamic voltage and frequency scaling for power management of a SoC. In another embodiment, flow diagram 300 is implemented within a computer system including a processor and memory coupled to the processor and having stored therein instructions that, if executed by the computer system causes the system to execute a method for performing closed loop dynamic voltage and frequency scaling for power management of a SoC. In still another embodiment, instructions for performing a method as outlined in flow diagram 300 are stored on a non-transitory computer-readable storage medium having computer-executable instructions for performing closed loop dynamic voltage and frequency scaling for power management of a SoC. In embodiments, the method of flow diagram 300 is implementable by one or more components of the computer system 100, and systems 200A-B of FIGS. 1 and 2A-B, respectively. In particular, the method of flow diagram 300 is implementable by the DVFS module 170 of FIG. 1, and CL-DVFS modules 205 of FIGS. 2A-B.

At 310, the method includes receiving a first performance request from a first engine of a SoC. As previously described in relation to FIGS. 2A-B, a SoC includes one or more components of an electronic system that is typically configured onto a single chip substrate. The SoC includes a plurality of engines, each of which is associated with a corresponding frequency vs. supply voltage curve that defines an optimum performance relationship between the two variables.

The performance request of the engine is determined at a particular moment in time depending on the load experienced or anticipated by the engine. Using a previous example, the engine may be tasked to operate a browser for purposes of loading a web page over a network. While downloading, the engine may request higher performance levels (e.g., frequency and/or supplied voltage) to guarantee quick downloading of the web page. Later, after the page has been downloaded, the engine may alter its performance request to a lower performance level that is more than capable of supporting the browsing of the downloaded web page. For example, at any point in time, the engine may request a clock frequency in consideration of the current task being performed, in one embodiment.

At 320, the method includes determining a first voltage and frequency point based on the first performance request. In one embodiment, the performance request includes a first, target clock frequency. As previously described, the engine has a corresponding frequency vs. supply voltage curve that defines its optimum performance requirements given either a requested clock frequency or a requested voltage that are supplied to the engine. That is, the frequency vs. supply voltage curve defines a plurality of voltage and frequency points required for optimal performance of the engine. Given a target clock frequency (e.g., requested clock frequency), a corresponding target supply voltage (e.g., requested supply voltage) can be determined. The requested supply voltage can be supplied to the engine for optimal performance when running at the requested clock frequency. Likewise, given a requested supply voltage, a corresponding requested clock frequency can also be determined. As such, when the engine requests a first requested clock frequency, based on the frequency vs. supply voltage curve the first voltage and frequency point derives a first requested voltage. In addition, when the engine requests the first requested voltage, the first requested clock frequency may also be determined based on the curve.

At 330, the method includes determining a first voltage rail of a plurality of voltage rails having a first supply voltage that is closest to the first requested voltage. In particular, a PMIC supplies varying levels of supply voltages (e.g., one or more Vdd levels) across a plurality of voltage rails. The PMIC is independent of the SoC, in one embodiment, and is configured to regulate and/or control the voltage levels supplied to the voltage rails. That is, the method outlined in flow diagram 300 for performing closed loop dynamic voltage and frequency scaling for power management of a SoC is implemented without communicating with the PMIC. In that manner, power management for an engine of the SoC is performed on-chip, without involving the off-chip PMIC. In particular, embodiments of the present invention provide for controlling and regulating the supplied voltages to each of the plurality of engines in the SoC without communicating with the PMIC. The PMIC is used to deliver supply voltages to the SoC that are further controlled and regulated. For example, in one embodiment, the voltages supplied by the PMIC to the voltage rails are constant for a period of time.

In one embodiment, the first supply voltage is equal to or greater than the first requested voltage. Further, the first supply voltage is closest to the required voltage, when compared to all voltage supplied by the plurality of voltage rails. That is, a coarse alignment is made between the voltage supplied to the engine from the voltage rails and the requested voltage that is determined based on the performance request and frequency vs. supply voltage curve. In some cases, if the first supply voltage is less than the first requested voltage, then the engine may fail during operation. However, if the first supply voltage is greater than the first requested voltage, the engine may continue to operate (e.g., for a given requested clock frequency), but may be inefficient.

At 340, the method includes coupling the first engine to the first voltage rail. In particular, the coupling is performed independently of the other engines in the SoC. That is, voltage and frequency alignment for optimum performance of an engine may be determined and performed independently of the voltage and frequency alignment requests of other engines located on the SoC. More importantly, the method outlined in FIG. 3 may be performed independently for each of the engines in the SoC, without regard to performance requirements of other engines. In particular, while the first engine is being coupled to the first voltage rail to receive a first requested voltage, a second performance request may embodiment received from a second engine of the SoC. A second voltage and frequency point may embodiment determined based on the second performance request, wherein the second voltage and frequency point comprises and/or points to a second requested voltage. A second voltage rail having a second supply voltage that is closest to the second requested voltage is determined, wherein the second voltage is equal to or greater than the second requested voltage. Further, the second engine is coupled to the second voltage rail independently of other engines in the SoC.

In another embodiment, further adjustment of the first supply voltage is performed to fine tuning the voltage that is delivered to the engine. In particular, the first supply voltage (e.g., coarsely voltage selection) from the first voltage rail is adjusted to match the requested voltage corresponding to the performance request using a LDO regulator. The LDO regulator is coupled between the engine and the first voltage rail. Moreover, a plurality of LDO regulators is coupled between the plurality of engines and the plurality of voltage rails, such that each of the engines can be coupled to a corresponding voltage rail via a corresponding LDO regulator. In that manner, a corresponding engine is configured to operate at its optimal target frequency and target supply voltage based on its frequency vs. supply voltage curve. For the current engine, because the coarsely selected first voltage from the first voltage rail is higher than the first requested voltage, the LDO is able to adjust and/or regulate an output voltage that matches the lower, first requested voltage.

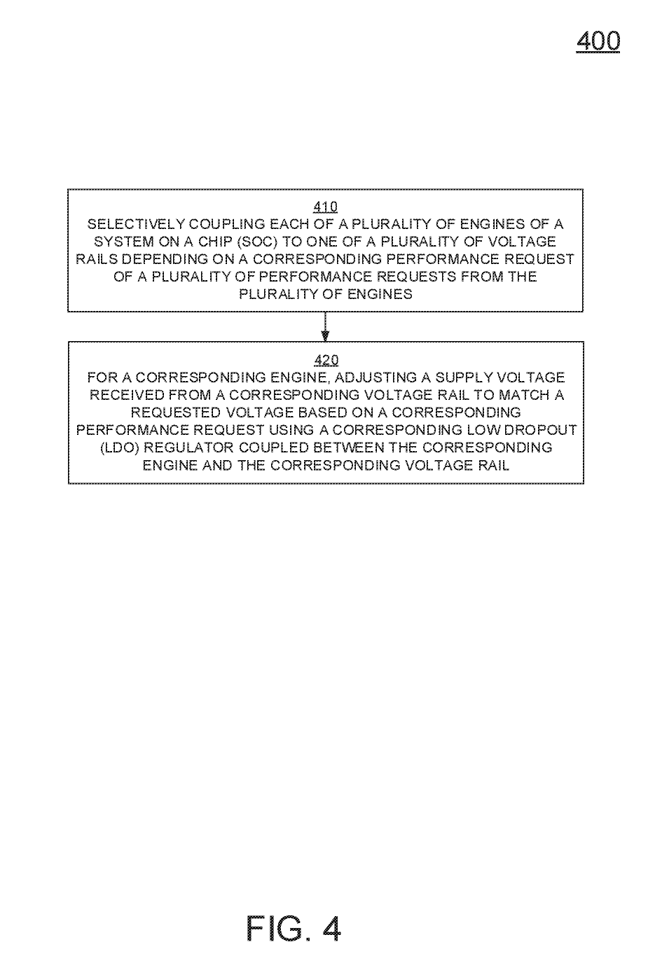

FIG. 4 is a flow diagram 400 illustrating a method for performing closed loop dynamic voltage and frequency scaling for power management of a SoC, in accordance with one embodiment of the present disclosure. In still another embodiment, flow diagram 400 illustrates a computer implemented method for performing closed loop dynamic voltage and frequency scaling for power management of a SoC. In another embodiment, flow diagram 400 is implemented within a computer system including a processor and memory coupled to the processor and having stored therein instructions that, if executed by the computer system causes the system to execute a method for performing closed loop dynamic voltage and frequency scaling for power management of a SoC. In still another embodiment, instructions for performing a method as outlined in flow diagram 400 are stored on a non-transitory computer-readable storage medium having computer-executable instructions for performing closed loop dynamic voltage and frequency scaling for power management of a SoC. In embodiments, the method of flow diagram 400 is implementable by one or more components of the computer system 100, and systems 200A-B of FIGS. 1 and 2A-B, respectively. In particular, the method of flow diagram 400 is implementable by the DVFS module 170 of FIG. 1, and CL-DVFS modules 205 of FIGS. 2A-B.

At 410, the method includes selectively coupling each of a plurality of engines of a SoC to one of a plurality of voltage rails depending on a corresponding performance request of a plurality of performance requests from the plurality of engines. As previously described in relation to FIGS. 2A-B, a SoC includes one or more components of an electronic system that is typically configured onto a single chip. The SoC includes a plurality of engines, each of which is associated with a corresponding frequency vs. supply voltage curve that defines an optimum performance relationship between the two variables. In addition, as previously described, for each engines a performance request is determined at a particular moment in time in consideration of the task currently being performed by the engine.

In particular, the selective coupling of a voltage rail to a corresponding engine is performed based on the voltage and frequency point of a corresponding frequency vs. supply voltage curve and corresponding performance request. As such, given a target clock frequency (e.g., requested frequency), a corresponding target supply voltage (e.g., requested voltage) can be determined. That is, when the corresponding engine requests a clock frequency, based on the frequency vs. supply voltage curve the voltage and frequency point also derives the corresponding requested voltage. As outlined in flow diagram 400, a voltage rail providing a supply voltage is selected for a corresponding engine depending on the determined requested voltage. In particular, the supply voltage that is selected is closest among all the supply voltages from the voltage rails to the requested voltage, wherein the selected supply voltage is equal to or greater than the requested voltage.

In one embodiment, voltage and frequency alignment for optimum performance of a corresponding engine may be determined and performed independently of the voltage and frequency alignment requests of other engines located on the SoC. That is, coarse alignment of the supply voltage and further fine tuning of the supply voltage is implemented by the method outlined in flow diagram 400.

At 420, for a corresponding engine, the method includes adjusting a supply voltage received from a corresponding voltage rail to match a requested voltage based on the corresponding performance request. A plurality of LDO regulators is coupled between the plurality of engines and the plurality of voltage rails, such that each of the engines can be coupled to a corresponding voltage rail via a corresponding LDO regulator. For a corresponding engine, a supply voltage is adjusted using a corresponding LDO regulator that is coupled between the corresponding engine and the corresponding voltage rail that supplies the coarsely selected supply voltage. That is, further adjustment of the supply voltage is performed to fine tune the supply voltage. For the current engine, because the coarsely selected voltage from the voltage rail is higher than the corresponding requested voltage, the LDO is able to adjust and/or regulate an output voltage that matches the lower, corresponding requested voltage.

Thus, according to embodiments of the present disclosure, systems and methods are described providing for performing closed loop dynamic voltage and frequency scaling for power management.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples in that many architectural variants can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the present disclosure are thus described. While the present disclosure has been described in particular embodiments, it should be appreciated that the disclosure should not be construed as limited by such embodiments, but rather construed according to the below claims.

What is claimed:

1. A method for power management, comprising:
receiving a first performance request from a first engine of a system on a chip (SoC);
determining a first voltage and frequency point based on said first performance request, wherein said first voltage and frequency point comprises a first requested voltage;
determining a first voltage rail of a plurality of voltage rails having a first supply voltage that is closest to said first requested voltage, wherein said first supply voltage is equal to or greater than said first requested voltage; and
coupling said first engine to said first voltage rail independently of other engines in said SoC.

2. The method of claim 1, further comprising:
adjusting said first supply voltage from said first voltage rail to match said requested voltage using a low dropout (LDO) regulator coupled between said engine and said first voltage rail.

3. The method of claim 1, wherein said first performance request comprises a requested frequency.

4. The method of claim 1, wherein said voltage and frequency point is determined from a frequency vs. supply voltage curve associated with said engine.

5. The method of claim 1, further comprising:
while said first engine is coupled to said first voltage rail to receive and generate a requested voltage, receiving a second performance request from a second engine of said system on a chip (SoC);
determining a second voltage and frequency point based on said second performance request, wherein said second voltage and frequency point comprises a second requested voltage;
determining a second voltage rail of said plurality of voltage rails having a second supply voltage that is closest to said second requested voltage, wherein said second supply voltage is equal to or greater than said second requested voltage; and
coupling said second engine to said second voltage rail independently of other engines in said SoC.

6. The method of claim 1, further comprising:
selectively coupling each of a plurality of engines to one of a plurality of voltage rails depending on a corresponding performance request of a plurality of performance requests from said plurality of engines; and
for a first engine, adjusting a supply voltage received from a corresponding voltage rail to match a requested voltage based on a corresponding performance request from said first engine using a low dropout (LDO) regulator coupled between said first engine and said corresponding voltage rail,
wherein said requested voltage is determined from a corresponding voltage and frequency point based on said corresponding performance request and wherein said frequency point comprises said corresponding requested voltage, wherein said voltage and frequency point is determined from a corresponding frequency vs. supply voltage curve associated with said first engine.

7. The method of claim 6, further comprising:
coupling a plurality of LDO regulators between said plurality of engines and said plurality of voltage rails, such that each of said plurality of engines is coupled to a corresponding voltage rail via a corresponding LDO regulator.

8. The method of claim 1, further comprising:
performing said method for scaling on said SoC without communicating with a power management integrated circuit (PMIC).

9. A method for power management, comprising:
selectively coupling each of a plurality of engines of a system on a chip (SoC) to one of a plurality of voltage rails depending on a corresponding performance request of a plurality of performance requests from said plurality of engines; and
for a corresponding engine, adjusting a supply voltage received from a corresponding voltage rail to match a requested voltage based on a corresponding performance request using a corresponding low dropout (LDO) regulator coupled between said corresponding engine and said corresponding voltage rail,
wherein said requested voltage is determined from a corresponding voltage and frequency point based on said corresponding performance request and wherein said frequency point comprises said corresponding requested voltage, wherein said voltage and frequency point is determined from a corresponding frequency vs. supply voltage curve associated with said corresponding engine.

10. The method of claim 9, wherein said selectively coupling comprises:
receiving a first performance request from a first engine of said SoC;
determining a first voltage and frequency point based on said first performance request, wherein said first voltage and frequency point comprises a first requested voltage;
determining a first voltage rail of a plurality of voltage rails having a first supply voltage that is closest to said first requested voltage, wherein said first supply voltage is equal to or greater than said first requested voltage; and
coupling said first engine to said first voltage rail independently of other engines in said SoC.

11. The method of claim 10, wherein said adjusting a voltage comprises:
adjusting said first supply voltage from said first voltage rail to match said requested voltage using a first low dropout (LDO) regulator coupled between said engine and said first voltage rail.

12. The method of claim 10, wherein said first performance request comprises a requested frequency.

13. The method of claim 9, wherein voltages on said plurality of voltage rails are constant.

14. An apparatus, comprising:
a plurality of voltage rails;
a system on a chip (SoC);
a plurality of engines integrated within said SoC, wherein said plurality of engines is coupled to said plurality of voltage rails;
a dynamic voltage and frequency scaling (DVFS) module coupled to said plurality of engines, wherein said DVFS module is configured to selectively couple each of said plurality of engines to one of said plurality of voltage rails depending on a corresponding performance request of a plurality of performance requests from said plurality of engines.

15. The apparatus of claim 14, further comprising:
a plurality of LDO regulators coupled between said plurality of engines and said plurality of voltage rails, such that each of said plurality of engines is selectively coupled to a corresponding voltage rail via a corresponding LDO regulator.

16. The apparatus of claim 15, wherein for a corresponding engine, a voltage received from a corresponding voltage rail is adjusted to match a requested voltage based on a corresponding performance request using a corresponding low dropout (LDO) regulator coupled between said corresponding engine and said corresponding voltage rail.

17. The apparatus of claim 16, wherein said requested voltage is determined from a corresponding voltage and frequency point based on said corresponding performance request and wherein said frequency point comprises said corresponding requested voltage, and wherein said voltage and frequency point is determined from a corresponding frequency vs. supply voltage curve associated with said corresponding engine.

18. The apparatus of claim 14, wherein said plurality of voltage rails is managed by a power management integrated circuit (PMIC) located remote from said SoC.

19. The apparatus of claim 18, wherein said plurality of voltage rails provide a plurality of constant supply voltages over a period of time.

20. The apparatus of claim 14, wherein said corresponding performance request comprises a corresponding requested frequency.
